(19) United States
(12) Patent Application Publication
(10) Pub. No.: US 2026/0236313 A1
(43) Pub. Date: Aug. 13, 2026

(54) HARDWARE-DEGRADATION-AWARE HYPERVISOR

(71) Applicant: INTERNATIONAL BUSINESS MACHINES CORPORATION, ARMONK, NY (US)

(72) Inventors: Jeffrey G. Chan, Brooklyn, NY (US); Craig R. Walters, Highland, NY (US); Seth E. Lederer, Staatsburg, NY (US); Hunter J. Kauffman, Decatur, GA (US)

(21) Appl. No.: 19/047,958

(22) Filed: Feb. 7, 2025

(51) Int. Cl. G06F 9/50; G06F 9/455; G06F 11/07

(52) U.S. Cl. CPC G06F 9/5044; G06F 9/45558; G06F 11/0772; G06F 2009/45591; G06F 2209/501

(57) ABSTRACT

Described are techniques for a hardware-degradation-aware hypervisor. The techniques include receiving, by a hypervisor that manages virtual machines on a server, an indication from a hardware unit of the server that the hardware unit is degraded. The techniques further include setting, by the hypervisor, a variable to indicate that the hardware unit is degraded. The techniques further include responsive to a resource allocation task, referencing the variable, by the hypervisor, and determining that the hardware unit is degraded. The techniques further include prioritizing, by the hypervisor, physical resources of the server that do not include the hardware unit that is degraded for allocation to one or more of the virtual machines managed by the hypervisor. The techniques further include allocating, by the hypervisor, the physical resources of the server to the one or more virtual machines based on the prioritizing of the physical resources.

### FIELD OF THE INVENTION

The present disclosure relates to virtualization, and, more specifically, to hypervisors for managing virtual machines.

### BACKGROUND

Virtualization technology has become increasingly prevalent in modern computing environments, allowing multiple virtual machines (VMs) to run on a single physical server. This approach offers numerous benefits, including improved resource utilization, flexibility, and cost-effectiveness. Hypervisors (also referred to as a virtual machine monitors) play a crucial role in managing these virtual environments by allocating hardware resources to VMs and ensuring their proper operation. A hypervisor is software that enables multiple VMs, each with its own operating system (OS), to execute on a physical server. The hypervisor creates and runs VMs on the physical server, and pools and allocates the physical computing resources of the server as needed by the VMs. The hypervisor manages the VMs and separates the VMs from each other logically by assigning each VM its own portion of the physical resources of the server, including processor units, memory units, and storage units.

### SUMMARY

Aspects of the present disclosure are directed toward a computer-implemented method comprising receiving, by a hypervisor that manages virtual machines on a server, an indication from a hardware unit of the server that the hardware unit is degraded. The computer-implemented method further comprising setting, by the hypervisor, a variable to indicate that the hardware unit is degraded. The computer-implemented method further comprising responsive to a resource allocation task, referencing the variable, by the hypervisor, and determining that the hardware unit is degraded. The computer-implemented method further comprising prioritizing, by the hypervisor, physical resources of the server that do not include the hardware unit that is degraded for allocation to one or more of the virtual machines managed by the hypervisor and allocating, by the hypervisor, the physical resources of the server to the one or more virtual machines based on the prioritizing of the physical resources.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of a computing system with a degradation-aware hypervisor, in accordance with some embodiments of the present disclosure.

FIG. 2 illustrates a flowchart of a method for managing hardware degradation in a virtualized computing environment, in accordance with some embodiments of the present disclosure.

FIG. 3 illustrates a flowchart of a method for handling hardware degradation in a virtualized computing environment, in accordance with some embodiments of the present disclosure.

FIG. 4 illustrates a flowchart of a method for rebalancing of hardware units to virtual machines when hardware degradation is present, in accordance with some embodiments of the present disclosure.

FIG. 5 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward a hardware-degradation-aware hypervisor. While not limited to such applications, embodiments of the present disclosure may be better understood in light of the following context.

In conventional virtualized computing environments, hypervisors manage the allocation of physical resources to virtual machines without considering potential hardware degradations. This approach may lead to suboptimal performance when hardware components or units experience degradation but remain operational. For example, a physical server configured for hosting virtual machines includes a hypervisor and a set of physical resources. These physical resources can include processors, memory, input and output (I/O) components, as well as other hardware units. This set of physical resources is referred to as a physical configuration of the server.

The concept of logical partitioning involves the division of the server's physical configuration into multiple logical partitions, on which virtual machines can be installed (i.e., a single virtual machine can be installed on a single logical partition). Logical partitioning is achieved through the use of the hypervisor. From the hypervisor perspective, each logical partition comes with a set of computing requirements, including processor, memory, and I/O requirements. This set of computing requirements is referred to as the logical configuration. This logical configuration can be, and is typically, different for each logical partition.

Logical partition placement maps a logical configuration to the physical configuration of the server. Logical partition placement is a factor in virtual machine performance because placement of the logical partition can determine cache access, memory access, and overall performance of the virtual machine. As such, placing a logical partition on a physical configuration that includes a degraded hardware unit can result in lower performance of the virtual machine installed on the logical partition. Any part of a computing system can become degraded, including a processor, memory, I/O, cooling, power, etc. Examples can include defective caches, degraded links (latency or bandwidth), reduced processor counts, reduced processor performance (throttling or other sub-degrades), degraded memory (throttling), higher latency across certain bus links, over-voltage, as well as other hardware units. As referred to herein, a hardware unit that is degraded, or a degraded hardware unit, is any hardware unit of a physical server that is experiencing reduced performance, increased error rates, and/or a higher risk of complete failure, such that the hardware unit is not functioning at its optimal level due to malperformance of hardware and/or software, but may still be functioning at a suboptimal level.

A physical server can include built-in redundancy to handle hardware unit performance degradation. However, there are situations where degradation of a hardware unit is unable to be contained by the built-in-redundancy. Without any knowledge about the hardware degradation, the hypervisor may assign a virtual machine to use the degraded hardware unit, resulting in reduced performance of the virtual machine.

Advantageously, aspects of the present disclosure overcome the challenges associated with degraded hardware units by providing information for degraded hardware units to a hardware-degradation-aware hypervisor to enable the hypervisor to avoid allocating the degraded hardware units to the virtual machines managed by the hypervisor. More specifically, aspects of the present disclosure include receiving, by the hypervisor, an indication from a hardware unit that the hardware unit is degraded. In aspects of the present disclosure, the hardware unit is configured to monitor itself for degradation and generate a hypervisor interrupt in response to detecting degradation of the hardware unit. In response to receiving the indication from the hardware unit, aspects of the present disclosure include setting, by the hypervisor, a variable indicating that the hardware unit is degraded. For example, a bit of a hardware-degradation bitmask can be set to a value that indicates the hardware unit is degraded. Thereafter, when performing a resource allocation task (e.g., creating a new virtual machine or rebalancing resource allocations to virtual machine), the hypervisor references the variable to identify the hardware unit that is degraded, and the hypervisor prioritizes the physical resources of the server that are not degraded for allocation to the virtual machines that are associated with the resource allocation task. The hypervisor then allocates the physical resources of the server to the virtual machines, such that the non-degraded hardware units are allocated first, and the degraded hardware units are only allocated if no other hardware units of the server are available.

The hardware-degradation-aware hypervisor represents an improvement over conventional hypervisors by providing a more resilient and efficient virtualization environment. By avoiding degraded hardware units, the system may maintain higher overall performance and reduce the impact of hardware issues on virtual machine operations. This approach may also extend the useful life of physical hardware by allowing continued use of partially degraded components in lower-priority tasks while reserving fully functional components for critical workloads. Accordingly, the hardware-degradation-aware hypervisor is an improvement in the technical field of virtualization generally, and more particularly, in the technical field of hypervisors. These advantages, as well as other advantages of the present disclosure are described below.

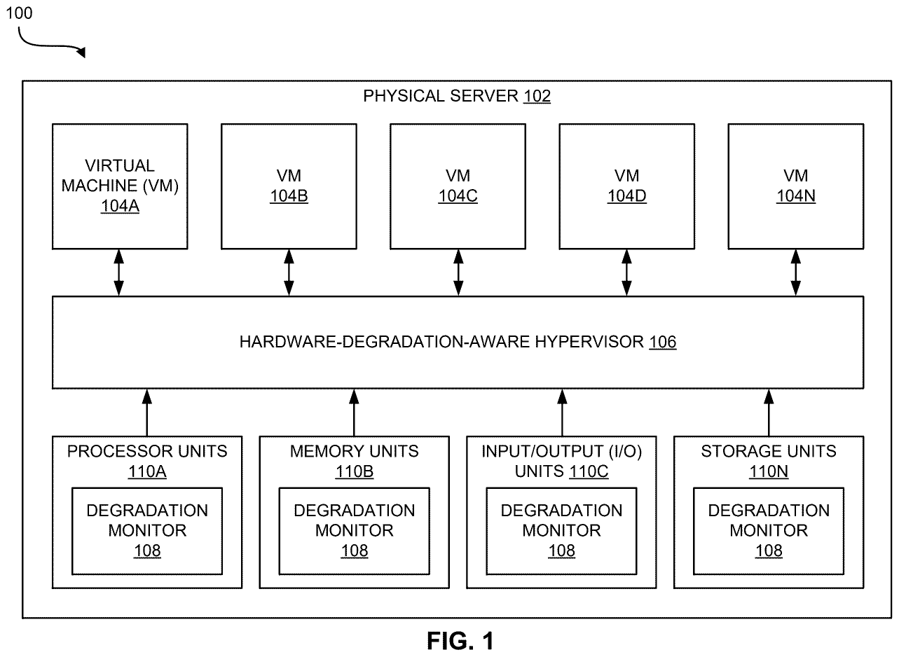

Referring now to the figures, FIG. 1 illustrates a block diagram of an example system 100 that can implement a hardware-degradation-aware hypervisor 106, in accordance with some embodiments of the present disclosure. As illustrated, the system 100 includes a physical server 102 configured as a host machine to execute virtual machines (VMs) 104A-N (collectively 104, where N can refer to any positive integer representing any number of VMs). The physical server 102 also includes a degradation-aware hypervisor 106 and a set of hardware units 110A-N (collectively 110, where N can refer to any positive integer representing any number of hardware units). The hardware units 110 can include, but are not limited to, processor units 110A, memory units 110B, I/O units 110C, storage units 110N, and other hardware units as will be appreciated by persons of ordinary skill.

In some embodiments, the degradation-aware hypervisor 106 interfaces with the set of hardware units 110A-N to receive, from any of the individual hardware units 110, an indication that an individual hardware unit 110A-N is degraded. In some embodiments, as will be described below, the system 100 may include shared memory for communications from the hardware units 110A-N. This shared memory can facilitate the exchange of information about hardware status and degradation events associated with the hardware units 110A-N.

In the illustrated example, the hardware units 110 are capable of monitoring themselves to detect degradation, or imminent degradation. For example, an individual hardware unit 110 is capable of detecting degradation or imminent degradation of the individual hardware unit 110. Illustratively, degradation detected by an individual hardware unit 110 is based on the type of hardware unit (e.g., processor unit 110A, memory unit 110B, input output unit 110C, storage unit 110N, etc.). A degradation detected by an individual hardware unit 110 can include: reduced performance, increased error rates, a condition that risks failure of the hardware unit 110 (e.g., overheating), or another condition that causes the hardware unit 110 to function at a suboptimal level.

In response to detecting degradation or imminent degradation, the hardware units 110 provide an indication of the degradation to the degradation-aware hypervisor 106. The indication of degradation can be communicated to the hardware-degradation-aware hypervisor 106 via an interrupt mechanism. When a hardware unit 110 experiences degradation, the hardware unit 110 can trigger an interrupt that is received by the hardware-degradation-aware hypervisor 106.

In the illustrated example, a hardware unit 110 includes a degradation monitor 108 to continuously monitor the operational status of the hardware unit 110. The degradation monitor 108 is specifically configured for the hardware unit 110 to monitor performance of the hardware unit 110 and detect performance degradation of the hardware unit 110. That is, the degradation monitor 108 can be configured to monitor a specific type of hardware configuration for performance degradation, such as a processor unit 110A, memory unit 110B, I/O unit 110C, storage unit, and other types of computing hardware. In some embodiments, the degradation monitor 108 can be implemented as processing circuitry (e.g., application-specific integrated circuit (ASIC)) on a hardware unit 110. In some embodiments, the degradation monitor 108 can be implemented using firmware code configured to detect performance degradation of a respective hardware unit 110. The firmware code can be configured to call upon the respective hardware unit 110 to send a degradation status to the hardware-degradation-aware hypervisor 106.

Responsive to detecting degradation of a hardware unit 110 on which the degradation monitor 108 is located, the degradation monitor 108 provides an indication of the degradation to the degradation-aware hypervisor 106. In some embodiments, the indication simply informs the hardware-degradation-aware hypervisor 106 that the hardware unit 110 associated with the indication is degraded in some way. In other embodiments, the indication includes additional information about the degradation, such as the type of degradation, the amount of degradation, the impact of the degradation, and/or other information about the degradation, as will be appreciated by a persons of ordinary skill.

In some embodiments, the degradation monitor 108 triggers an interruption mechanism to notify the hardware-degradation-aware hypervisor 106 of performance degradation of a respective hardware unit 110. This interruption mechanism may involve sending a specific interrupt signal to the hardware-degradation-aware hypervisor 106, indicating the occurrence of a hardware degradation event. Responsive to receiving the interrupt signal, the hardware-degradation-aware hypervisor 106 processes the interruption and extracts relevant information about the detected hardware degradation. The interrupt, in some embodiments, comprises a machine check interruption code (MCIC). The MCIC can be a specific code generated by the degradation monitor 108 in response to detecting performance degradation, including critical hardware errors (e.g., faulty memory access or bus error).

In some embodiments, a hardware-degradation bitmask is used to track degradation of hardware units 110 reported to the hardware-degradation-aware hypervisor 106 by the degradation monitors 108. The bits of the bitmask indicate a machine check condition of a particular hardware unit 110. The hardware-degradation-aware hypervisor 106 references the bitmask when performing resource allocation tasks. Illustratively, the bitmask can be set to one (1) to indicate a normally functioning hardware unit 110, and to zero (0) to indicate a degraded functioning hardware unit 110. As a simple illustration, given that the system 100 includes thirty two (32) hardware units 110, each bit of a bitmask can be assigned to one of the hardware units 110. The bitmask representing a normally functioning system 100 can comprise:

$$11 \; 111111 \_ 11111111 \_ 11111111 \_ 11111111$$

In the event that a degradation monitor 108 located on a hardware unit 110 (e.g., a processor unit 110A) detects performance degradation of the hardware unit 110, the degradation monitor 108 can set a bit assigned to the hardware unit 110 to indicate the degraded performance (e.g., degraded CPU utilization, cache utilization, etc.), such that the bitmask for the system 100 comprises:

$$1 \; 1110111 \_ 11111111 \_ 11111111 \_ 11111111$$

where the fifth bit in the bitmask indicates that the hardware unit 110 associated with the fifth bit is degraded, and the remaining bits indicate that the hardware units 110 associated with the remaining bits are performing normally.

In embodiments were the degradation monitor 108 is configured to provide additional information about a performance degradation of a hardware unit 110 on which the degradation monitor 108 is located, a shared buffer can be used to enable the hardware unit 110 to provide the additional information to the hardware-degradation-aware hypervisor 106. In such an embodiment, the hardware-degradation-aware hypervisor 106 allocates buffer locations to the hardware units 110, and each individual hardware unit 110 accesses an allocated buffer location using a pointer in a prefix page field (where the prefix page contains information about the hardware unit 110) to provide performance degradation information to the hardware-degradation-aware hypervisor 106. As an illustration, responsive to detecting performance degradation, a degradation monitor 108 on a hardware unit 110 collects information about the performance degradation (e.g., an amount of degradation, an impact of the degradation, and/or other information about the degradation) and accesses an allocated location in the shared buffer (using the pointer in the prefix page field) to store the performance degradation information. The degradation monitor 108 sets a respective bit in the bitmask to indicate that the hardware unit 110 is degraded. At the same time, or thereafter, the degradation monitor 108 generates an interruption to the hardware-degradation-aware hypervisor 106. This interrupts the hardware-degradation-aware hypervisor 106 (e.g., via a machine check first-level interrupt handler), and the hardware-degradation-aware hypervisor 106 evaluates the bitmask to determine that the bit assigned to the hardware unit 110 is set to indicate degraded performance of the hardware unit 110. The hardware-degradation-aware hypervisor 106 then accesses the buffer location of the shared buffer allocated to the hardware unit 110 to obtain the information about the performance degradation of the hardware unit 110 and, based on the performance degradation information, performs (e.g., via a machine check second-level interrupt handler) a resource allocation task based on the performance degradation information.

In other embodiments were the degradation monitor 108 is configured to provide additional information about a performance degradation of a hardware unit 110 on which the degradation monitor 108 is located, a shared hardware hypervisor memory area can be used to provide the additional information to the hardware-degradation-aware hypervisor 106. In some embodiments, the shared hardware hypervisor memory area can contain pointers to other shared areas of memory that store larger amounts of data about a performance degradation of a hardware unit 110. The individual hardware units 110 store performance degradation information to an area of the shared hardware hypervisor memory in order to provide the performance degradation information to the hardware-degradation-aware hypervisor 106. As an illustration, responsive to detecting performance degradation, a degradation monitor 108 on a hardware unit 110 collects information about the performance degradation and stores the performance degradation information to a designated area of the shared hardware hypervisor memory. The degradation monitor 108 sends an interrupt with a degradation interrupt code to the hardware-degradation-aware hypervisor 106. In response, the hardware-degradation-aware hypervisor 106 (via a first-level interrupt handler) accesses the designated area of the shared hardware hypervisor memory to obtain the performance degradation information, and (via a second-level interrupt handler) performs a resource allocation task based on the performance degradation information. Below is a non-limiting example of a shared hardware hypervisor memory and example degradation interruption codes.

| Offset | Field | Description |
|---|---|---|
| 0 − N | . . . | Other unrelated |
| N − N + 7 | Degradation Interruption | Hardware unit address |
| | First-Level Interrupt | associated with degradation |
| | Handler | interruption. |
| | | Set by hypervisor. |
| N + 8 − | Degradation Interruption | Type of degradation interrupt. |
| N + 9 | Code | Set by hardware unit. |
| N + 10 − | CPU Speed Deg Report | Information about degraded |
| N + 17 | Address | CPU speeds. |
| | | Address set by hypervisor. |
| | | Field filled by hardware unit |
| | | prior to triggering |
| | | interruption. |
| N + 18 − | IO Degradation | Information about CPUs with |
| N + 25 | Performance | degraded IO capabilities. |
| | Report Address | Address set by hypervisor. |
| | | Field filled by hardware unit |
| | | prior to triggering |
| | | interruption. |
| N + 26 − | Memory Degradation | Information about degraded |
| N + 33 | Report Address | memory increments. |
| | | Address set by hypervisor. |
| | | Field filled by hardware unit |
| | | prior to triggering |
| | | interruption. |
| | . . . | Other report areas |
| | . . . | Other unrelated |

| Degradation | |
|---|---|
| Interruption | |
| Code | Definition |
| 9001 | CPU Speed Degradation |
| 9002 | I/O Capability Degradation |
| 9003 | Shared Cache Degradation |
| 9004 | Memory Increment Degradation |
| . . . | . . . |

The hardware-degradation-aware hypervisor 106 utilizes information about degraded hardware units 110 to perform resource allocation tasks. For example, the hardware-degradation-aware hypervisor 106 can prioritize normally functioning hardware units 110 for allocation to VMs 104. By doing so, non-degraded hardware units are allocated first, and the degraded hardware units are allocated last, in the event that the degraded hardware units are needed.

The following examples illustrate how various types of hardware units 110 use the shared hardware hypervisor memory area to report hardware degradation to the hardware-degradation-aware hypervisor 106.

In a scenario involving a processor unit 110A, the degradation monitor 108 located on the processor unit 110A detects that the processor unit 110A is operating at a degraded speed. In response, the processor unit 110A writes information about the degraded processor speed (e.g., processor speed value) to a designated area (e.g., field) of the shared hardware hypervisor memory, and then sends an interrupt with a speed degradation interruption code to the hardware-degradation-aware hypervisor 106. The hardware-degradation-aware hypervisor 106 receives the interrupt and accesses the area of the shared hardware hypervisor memory containing the information about the degraded processor speed. Thereafter, the hardware-degradation-aware hypervisor 106 performs resource allocation tasks based on the information about the degraded processor speed.

In a scenario involving an I/O unit 110C, the degradation monitor 108 located on the I/O unit 110C detects that I/O bandwidth capacity is degraded. In response, the I/O unit 110C writes information about the degraded bandwidth capacity (e.g., a bandwidth capacity value) to a designated area (e.g., field) of the shared hardware hypervisor memory, and then sends an interrupt with a I/O bandwidth degradation interruption code to the hardware-degradation-aware hypervisor 106. The hardware-degradation-aware hypervisor 106 receives the interrupt and accesses the area of the shared hardware hypervisor memory containing the information about the degraded I/O bandwidth. Thereafter, the hardware-degradation-aware hypervisor 106 performs resource allocation tasks based on the information about the degraded I/O bandwidth.

In a scenario involving a memory unit 110B, the degradation monitor 108 located on the memory unit 110B detects poor performance of failure of specific memory increments. In response, the memory unit 110B writes information about the degraded memory increments (e.g., memory addresses and type of degradation) to a designated area (e.g., field) of the shared hardware hypervisor memory, and then sends an interrupt with a memory degradation interruption code to the hardware-degradation-aware hypervisor 106. The hardware-degradation-aware hypervisor 106 receives the interrupt and obtains the information about the degraded memory increments from the area of the shared hardware hypervisor memory. Thereafter, the hardware-degradation-aware hypervisor 106 performs resource allocation tasks based on the information about the degraded memory increments.

By maintaining awareness of hardware degradation, the hardware-degradation-aware hypervisor 106 improves the performance and reliability of the VMs 104 running on the physical server 102. This approach allows for more efficient use of available resources and helps to mitigate the impact of hardware degradation on overall system performance.

In some embodiments, as part of monitoring a hardware unit 110 to detect degradation of the hardware unit 110, the degradation monitor 108 can also detect that performance degradation of the hardware unit 110 has been resolved. As an example involving a processor unit 110A that is operating at a degraded processor speed, the degradation monitor 108 can detect when the processor speed is again operating at a normal speed. In the event that the degradation monitor 108 detects that performance degradation of a hardware unit 110 has been resolved, the degradation monitor 108 sends an indication (e.g., an interrupt) to the hardware-degradation-aware hypervisor 106 that degradation of the hardware unit 110 has been resolved. In response, the hardware-degradation-aware hypervisor 106 notes that the hardware unit 110 is operating normally (e.g., by updating a respective bit in a hardware-degradation bitmask or updating a shared hardware hypervisor memory area), such that the hardware unit 110 can be prioritized for allocation to the VMs 104.

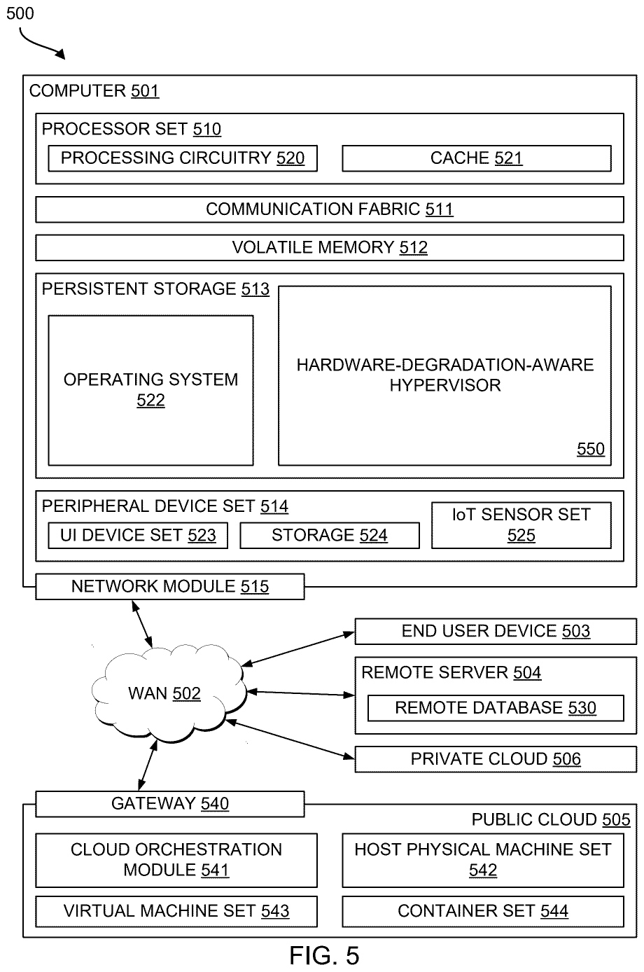

All or a portion of the system 100 shown in FIG. 1 can be implemented, for example by all or a subset of the computing environment 500 of FIG. 5. The hardware-degradation-aware hypervisor 106 can be implemented in software, hardware, firmware or a combination thereof. In some embodiments, the degradation-aware hypervisor 106 can comprise a “Type 1” (or “bare metal”) hypervisor that acts as a lightweight operating system that executes on the hardware of the physical host 102. In some embodiments, the degradation-aware hypervisor 106 can comprise a “Type 2” (or “hosted”) hypervisor that executes as a software layer on the physical host's operating system. When software is used, the operations performed by hardware-degradation-aware hypervisor 106 can be implemented in program instructions configured to run on hardware, such as a processor. When firmware is used, the operations performed by the hardware-degradation-aware hypervisor 106 can be implemented in program instructions and data and stored in persistent memory to run on a processor. When hardware is employed, the hardware can include circuits that operate to perform the operations of the hardware-degradation-aware hypervisor 106.

In some embodiments, aspects of the system 100 can be implemented using modules. Generally, modules (also referred to as program modules) include routines, programs, components and/or data structures that perform particular tasks and/or implement particular abstract data types. In some embodiments, the modules can be implemented as computing services hosted in a computing service environment (e.g., cloud environment). For example, a module can be considered a service with one or more processes executing on a server or other computer hardware. Such services can provide a service application that receives requests and provides output to other services or consumer devices. An application programming interface (API) can be provided for each module to enable a first module to send requests to and receive output from a second module. Such APIs can also allow third parties to interface with the module and make requests and receive output from the modules. While FIG. 1 illustrates an example of a computational environment that can implement the techniques above, many other similar or different environments are possible. The example environments discussed and illustrated above are merely representative and not limiting.

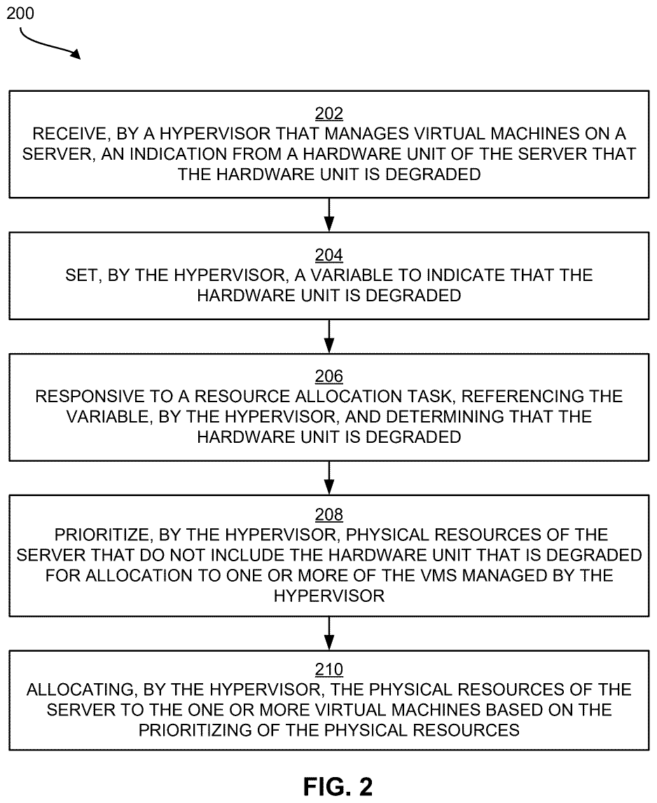

FIG. 2 illustrates a flowchart of an example method 200 for managing hardware degradation in a virtualized computing environment, in accordance with some embodiments of the present disclosure. Beginning at operation 202, a hypervisor (e.g., the hardware-degradation-aware hypervisor 106 described earlier), that manages virtual machines on a server, receives an indication from a hardware unit of the server that the hardware unit is degraded. The hardware unit is configured to monitor for degradation of the hardware unit and send the indication in response to detecting that performance of the hardware unit is degraded. In some embodiments, the indication is an interrupt generated by the hardware unit. The interrupt can include an identity of the hardware unit (e.g., hardware identifier) and an indication that the performance of the hardware unit is degraded.

In operation 204, the hypervisor sets a variable to indicate that the hardware unit is degraded. In some embodiments, the variable is a bit in a hardware-degradation bitmask. Each bit of the hardware-degradation bitmask corresponds to a particular hardware unit for allocation to the virtual machines, and a bit corresponding to the hardware unit can be set to a value that indicates the hardware unit is degraded.

In operation 206, as part of performing a resource allocation task, the hypervisor references the variable to determine whether the hardware unit is degraded. The resource allocation task may involve, for example, an initial placement of virtual machines, rebalancing of existing virtual machines, or adjusting resource allocations in response to changing workloads or system conditions.

In determining that the variable indicates that the hardware unit is degraded, the hypervisor, in operation 208, prioritizes the physical resources of the server that do not include the degraded hardware unit for allocation to the virtual machines managed by the hypervisor. For example, the hypervisor can prioritize normally functioning hardware units to be first allocated to the virtual machines, and if additional hardware units are needed after allocating the normally functioning hardware units, the hypervisor can then allocate the degraded hardware units to the virtual machines. When degraded hardware units need to be allocated to the virtual machines, a hardware unit that has an amount of degradation that is less than other degraded hardware units can be allocated first.

In some embodiments, the prioritization may involve creating a priority list of virtual machines based on their entitlement to normally functioning hardware units. The hypervisor will allocate the normally functioning hardware units to the prioritized virtual machines first, and only allocate the degraded hardware units to lower priority virtual machines in the event that the normally functioning hardware units have all been allocated.

In operation 210, the hypervisor allocates the physical resources of the server to the virtual machines based on the prioritization of the physical resources performed above. This allocation can take into account the prioritization performed in the previous operation, ensuring that non-degraded hardware units are not allocated whenever possible. In cases where the server is fully configured, such that all hardware units are allocated to virtual machines, the hypervisor may prefer normally functioning hardware units and only use the degraded hardware units for the lowest priority virtual machines. This approach may help maintain optimal performance for critical workloads while still utilizing all available resources efficiently.

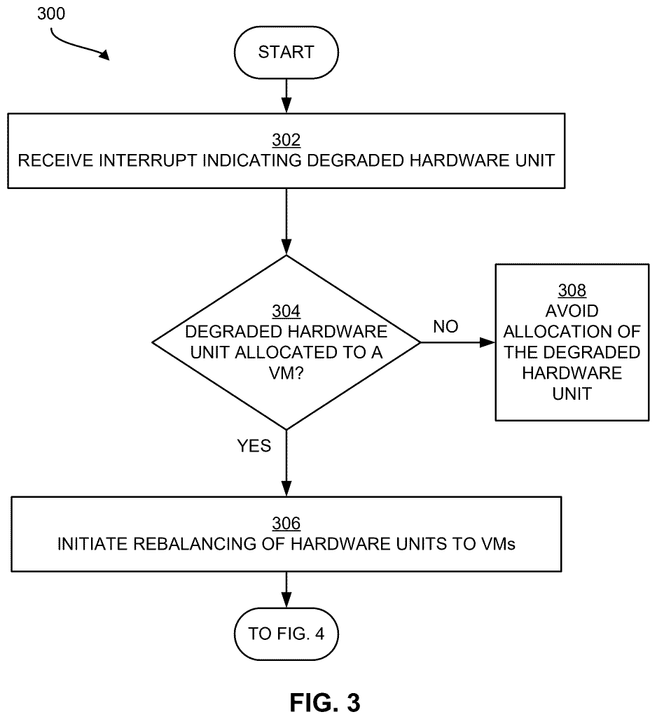

Moving now to FIG. 3, which illustrates a flowchart of a method 300 for handling hardware degradation in a virtualized computing environment, in accordance with some embodiments of the present disclosure. As in operation 302, an interrupt indicating a degraded hardware unit is received. This interrupt may be triggered by a degradation monitor associated with a specific hardware unit, as described earlier.

Following this, the method 300 in operation 304, determines whether the degraded hardware unit is allocated to a virtual machine. For example, the hypervisor checks whether any of the virtual machines managed by the hypervisor are currently utilizing the degraded hardware unit. If the hypervisor determines that the degraded hardware unit is not allocated to a virtual machine, the method 300 proceeds to operation 308, where allocation of the degraded hardware unit is avoided. For example, the hypervisor can update its internal data structures to prevent future allocation of the degraded hardware unit to virtual machines managed by the hypervisor.

If the hypervisor determines that the degraded hardware unit is currently allocated to a virtual machine, the method 300 proceeds to operation 306, where rebalancing of hardware units to virtual machines is initiated. This rebalancing process may involve reallocating normally functioning hardware units to the affected virtual machine, as described below.

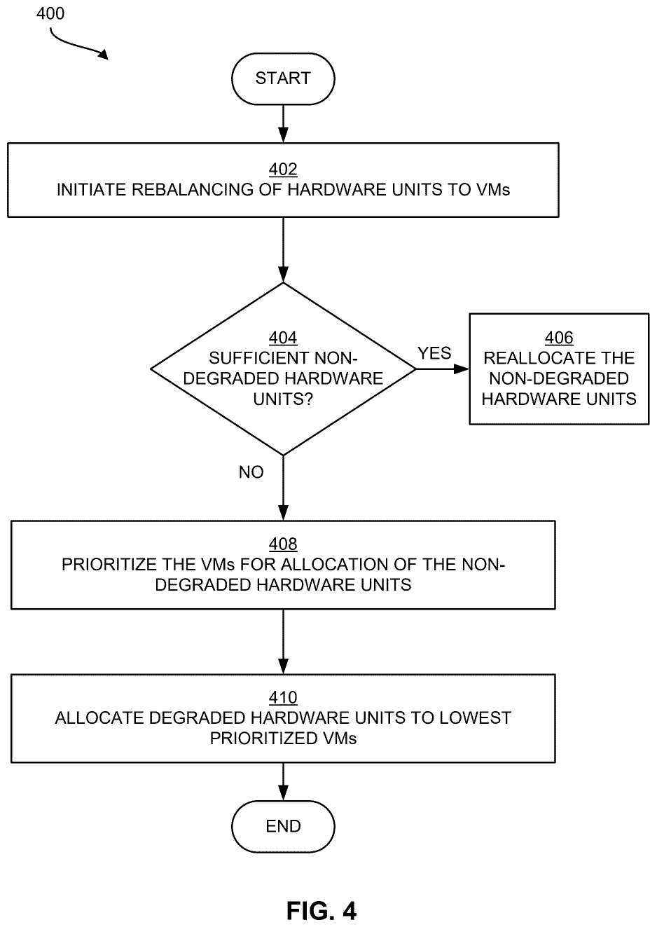

FIG. 4 illustrates a flowchart of a method 400 for rebalancing of hardware units to virtual machines when hardware degradation is present, in accordance with some embodiments of the present disclosure. The method 400 may begin with operation 402, which initiates the rebalancing of hardware units to virtual machines. This rebalancing process can be triggered when the hypervisor detects a hardware degradation in one of the hardware units.

The process then flows to operation 404, where a determination may be made whether there are sufficient non-degraded hardware units available for allocation to the virtual machines. The hypervisor can assess the current state of the hardware units within the server to determine whether there are sufficient normally functioning hardware units to meet the resource requirements of all the virtual machines. If the determination at operation 404 is affirmative, the hypervisor has sufficient non-degraded hardware units to allocate to all the virtual machines without needing to use any degraded components. Accordingly, the method 400 proceeds to operation 406, which reallocates the non-degraded hardware units to the virtual machines, such that any virtual machines that had been allocated a degraded hardware unit have been migrated to normally functioning hardware units.

If the determination at operation 404 is negative, the process continues to operation 408. In operation 408, the hypervisor prioritizes the virtual machines for allocation of the non-degraded hardware units. In some cases, this prioritization may be based on factors such as the importance of the workload running on each virtual machine, service level agreements, or resource requirements. Following the prioritization, in operation 410, the hypervisor allocates the degraded hardware units to the lowest prioritized virtual machines. This allocation strategy can ensure that critical or high-priority workloads running on virtual machines are assigned to non-degraded hardware units whenever possible. Lower priority virtual machines may be allocated to the degraded hardware units if necessary.

The resource allocation strategy implemented by the method 400 may allow the hypervisor to maintain optimal performance for critical workloads while still utilizing all available resources efficiently, even in the presence of hardware degradations within the physical server.

In some embodiments, the hypervisor may also handle scenarios where previously degraded hardware units return to normal operation. In such cases, the hypervisor may receive an interrupt indicating the improved status, update its internal data structures, and adjust its resource allocation strategies accordingly. This dynamic resolution of hardware degradations may allow the system to efficiently utilize all available resources as their status changes over time.

The methods described in FIGS. 3 and 4 above can be performed by a computer (e.g., computer 501 in FIG. 5), performed in a cloud environment (e.g., clouds 506 or 505 in FIG. 5), and/or generally can be implemented in fixed-functionality hardware, configurable logic, logic instructions, etc., or any combination thereof.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage media or medium, as the terms are used in the present disclosure, are not to be construed as storage in the form of transitory signals per se. Namely, a computer-readable storage media or medium is not radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 500 contains an example of an environment for the execution of at least some of the computer code involved in performing the disclosed methods, such as computer code for a hardware-degradation-aware hypervisor 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer-readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as cache 521 and the other storage media discussed below. The computer-readable program instructions, and associated data, are accessed by processor set 510 to control and direct performance of the disclosed methods. In computing environment 500, at least some of the instructions for performing the disclosed methods may be stored in block 550 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in block 550 typically includes at least some of the computer code involved in performing the disclosed methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer-readable program instructions for performing the disclosed methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. The term “user” refers to an entity (e.g., an individual(s), a computer, or an application executing on a computer). It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. It is also to be understood that the terms “approximately” or “substantially” as used herein with regard to percentages, ranges, times and other process parameters, etc., are meant to denote being close or approximate to, but not exactly.

In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure. Note further that numerous aspects or features are disclosed herein, and unless inconsistent, each disclosed aspect or feature is combinable with any other disclosed aspect or feature as desired for a particular application of the concepts disclosed.

As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art. Any advantages discussed in the present disclosure are example advantages, and embodiments of the present disclosure can exist that realize all, some, or none of any of the discussed advantages while remaining within the spirit and scope of the present disclosure.

It will be further appreciated that various aspects of the present invention may be provided in the form of a service deployed on behalf of a customer to offer service on demand.

The descriptions of the various aspects of the present invention have been presented for purposes of illustration, but are not intended to be exhaustive or limited to the approaches disclosed. Many modifications and variations will be apparent to those of ordinary skill in the art without departing from the scope and spirit of the described aspects. The terminology used herein was chosen to best explain the principles of the various aspects described, the practical application or technical improvement over technologies found in the marketplace, or to enable others of ordinary skill in the art to understand the approaches disclosed herein.

What is claimed is:

1. A computer-implemented method comprising:
receiving, by a hypervisor that manages virtual machines on a server, an indication from a hardware unit of the server that the hardware unit is degraded;
setting, by the hypervisor, a variable to indicate that the hardware unit is degraded;
responsive to a resource allocation task, referencing the variable, by the hypervisor, and determining that the hardware unit is degraded;
prioritizing, by the hypervisor, physical resources of the server that do not include the hardware unit that is degraded for allocation to one or more of the virtual machines managed by the hypervisor; and
allocating, by the hypervisor, the physical resources of the server to the one or more virtual machines based on the prioritizing of the physical resources.

2. The computer-implemented method of claim 1, wherein receiving the indication that the hardware unit of the server is degraded further comprises:
receiving, at the hypervisor, an interrupt generated by the hardware unit, the interrupt indicating an identity of the hardware unit and that the hardware unit is degraded,
wherein the hardware unit is configured to monitor for degradation of the hardware unit, and generate the interrupt in response to detecting degradation of the hardware unit.

3. The computer-implemented method of claim 1, wherein receiving the indication that the hardware unit of the server is degraded further comprises:
receiving an indication of an amount of degradation of the hardware unit, wherein the hardware unit is configured to detect the amount of degradation of the hardware unit; and
responsive to allocating the physical resources of the server to a virtual machine, allocating first, a hardware unit that has an amount of degradation that is less than the amount of degradation of the hardware unit.

4. The computer-implemented method of claim 1, wherein setting the variable to indicate that the hardware unit is degraded further comprises:
setting a bit of a hardware-degradation bitmask to a value that indicates the hardware unit is degraded, wherein each bit of the hardware-degradation bitmask corresponds to a particular hardware unit for allocation to the virtual machines.

5. The computer-implemented method of claim 1, wherein setting the variable indicating that the hardware unit is degraded further comprises:
determining that the hardware unit is currently allocated to a virtual machine; and
initiate rebalancing of the physical resources of the server to the virtual machines.

6. The computer-implemented method of claim 1, further comprising:
prioritizing the virtual machines for allocation of the physical resources of the server;
responsive to allocating the physical resources of the server to the virtual machines, allocating the hardware unit that is degraded to a lowest prioritized virtual machine when a non-degraded hardware unit is not available.

7. The computer-implemented method of claim 1, further comprising:
receiving, at the hypervisor from the hardware unit, that degradation of the hardware unit has been resolved; and
setting, by the hypervisor, an indication that the hardware unit is performing normally.

8. A computer system comprising:
a processor set;
one or more computer-readable storage media; and
program instructions stored on the one or more computer-readable storage media to cause the processor set to perform operations comprising:
receiving, by a hypervisor that manages virtual machines on a server, an indication from a hardware unit of the server that the hardware unit is degraded;
setting, by the hypervisor, a variable to indicate that the hardware unit is degraded;
responsive to a resource allocation task, referencing the variable, by the hypervisor, and determining that the hardware unit is degraded;
prioritizing, by the hypervisor, physical resources of the server that do not include the hardware unit that is degraded for allocation to one or more of the virtual machines managed by the hypervisor; and
allocating, by the hypervisor, the physical resources of the server to the one or more virtual machines based on the prioritizing of the physical resources.

9. The computer system of claim 8, wherein receiving the indication that the hardware unit of the server is degraded further comprises:
receiving, at the hypervisor, an interrupt generated by the hardware unit, the interrupt indicating an identity of the hardware unit and that the hardware unit is degraded,
wherein the hardware unit is configured to monitor for degradation of the hardware unit, and generate the interrupt in response to detecting degradation of the hardware unit.

10. The computer system of claim 8, wherein receiving the indication that the hardware unit of the server is degraded further comprises:
receiving an indication of an amount of degradation of the hardware unit, wherein the hardware unit is configured to detect the amount of degradation of the hardware unit; and
responsive to allocating the physical resources of the server to a virtual machine, allocating first, a hardware unit that has an amount of degradation that is less than the amount of degradation of the hardware unit.

11. The computer system of claim 8, wherein setting the variable to indicate that the hardware unit is degraded further comprises:
setting a bit of a hardware-degradation bitmask to a value that indicates the hardware unit is degraded, wherein each bit of the hardware-degradation bitmask corresponds to a particular hardware unit for allocation to the virtual machines.

12. The computer system of claim 8, wherein setting the variable indicating that the hardware unit is degraded further comprises:
determining that the hardware unit is currently allocated to a virtual machine; and
initiate rebalancing of the physical resources of the server to the virtual machines.

13. The computer system of claim 8, wherein the operations further comprise:
prioritizing the virtual machines for allocation of the physical resources of the server;
responsive to allocating the physical resources of the server to the virtual machines, allocating the hardware unit that is degraded to a lowest prioritized virtual machine when a non-degraded hardware unit is not available.

14. The computer system of claim 8, wherein the operations further comprise:
receiving, at the hypervisor from the hardware unit, that degradation of the hardware unit has been resolved; and
setting, by the hypervisor, an indication that the hardware unit is performing normally.

15. A computer program product comprising:
one or more computer-readable storage media; and
program instructions stored on the one or more computer-readable storage media to cause a processor set to perform operations comprising:
receiving, by a hypervisor that manages virtual machines on a server, an indication from a hardware unit of the server that the hardware unit is degraded;
setting, by the hypervisor, a variable to indicate that the hardware unit is degraded;
responsive to a resource allocation task, referencing the variable, by the hypervisor, and determining that the hardware unit is degraded;
prioritizing, by the hypervisor, physical resources of the server that do not include the hardware unit that is degraded for allocation to one or more of the virtual machines managed by the hypervisor; and
allocating, by the hypervisor, the physical resources of the server to the one or more virtual machines based on the prioritizing of the physical resources.

16. The computer program product of claim 15, wherein receiving the indication that the hardware unit of the server is degraded further comprises:
receiving, at the hypervisor, an interrupt generated by the hardware unit, the interrupt indicating an identity of the hardware unit and that the hardware unit is degraded,
wherein the hardware unit is configured to monitor for degradation of the hardware unit, and generate the interrupt in response to detecting degradation of the hardware unit.

17. The computer program product of claim 15, wherein receiving the indication that the hardware unit of the server is degraded further comprises:
receiving an indication of an amount of degradation of the hardware unit, wherein the hardware unit is configured to detect the amount of degradation of the hardware unit; and
responsive to allocating the physical resources of the server to a virtual machine, allocating first, a hardware unit that has an amount of degradation that is less than the amount of degradation of the hardware unit.

18. The computer program product of claim 15, wherein setting the variable indicating that the hardware unit is degraded further comprises:
determining that the hardware unit is currently allocated to a virtual machine; and
initiate rebalancing of the physical resources of the server to the virtual machines.

19. The computer program product of claim 15, wherein the operations further comprise:
prioritizing the virtual machines for allocation of the physical resources of the server;
responsive to allocating the physical resources of the server to the virtual machines, allocating the hardware unit that is degraded to a lowest prioritized virtual machine when a non-degraded hardware unit is not available.

20. The computer program product of claim 15, wherein the operations further comprise:
receiving, at the hypervisor from the hardware unit, that degradation of the hardware unit has been resolved; and
setting, by the hypervisor, an indication that the hardware unit is performing normally.
